(19) United States
(12) Patent Application Publication
(10) Pub. No.: US 2026/0264598 A1
(43) Pub. Date: Sep. 10, 2026

(54) ANTI-THEFT CAM BUCKLE AND STRAP

(71) Applicant: Southeast Sourcing, LLC, Greenville, SC (US)

(72) Inventor: Beau ALEWINE, Greenville, SC (US)

(21) Appl. No.: 19/561,290

(22) Filed: Mar. 9, 2026

Related U.S. Application Data
(60) Provisional application No. 63/768,380, filed on Mar. 7, 2025.

(51) Int. Cl. B60P 7/08; A44B 11/12

(52) U.S. Cl. CPC B60P 7/0838; A44B 11/125

(57) ABSTRACT

Described herein is an improved cam buckle and strap mechanism to enhance security of materials secured by the cam buckle and strap by including an improved locking mechanism on the cam as well as providing internal reinforcements to the strap.

### TECHNICAL FIELD

The subject matter disclosed herein is generally directed to an improved cam buckle and strap mechanism to enhance security of materials secured by the cam buckle and strap by including an improved locking mechanism on the cam as well as providing internal reinforcements to the strap.

### BACKGROUND

Securing items to a platform, trailer, or other storage or hauling mechanism is a common occurrence. Various attempts are known in the art. Conventional cam buckle and ratchet straps can be loosened quickly by actuating a release lever, and typical textile webbing is readily severed with a knife. Users transporting high-value goods (e.g., motorcycles) have therefore faced theft risks when leaving equipment unattended in a truck bed or on a trailer.

For instance, US 2023/0249603, Locking Ratchet Strap Device, provides a locking ratchet strap that prevents theft and unintentional cargo loss. The device has a first strap and a second strap that attach to a ratchet mechanism which allows the straps to tighten. Each strap is made from a cut-resistant material. A release catch of the ratcheting mechanism is comprised of a lock that prevents the mechanism from becoming loose or operated by an unauthorized user (i.e., a thief). Each strap may be comprised of a hook having a lock member that can be manipulated from within each hook to form each hook into a continuous loop. The lock member can then be locked into this position via a lock. This prevents the hooks from becoming unsecured from an anchor point during transport. (Abstract.) However, no locking mechanism is provided for the cam buckle and the straps are not internally reinforced.

U.S. Pat. No. 6,524,041, Locking ratchet for a lashing mechanism, provides tie-down assembly for securing an article by a strap has a frame to which one end of the strap is immovably connected and a winding shaft about which the other end of the strap is wound and unwound. A handle pivoted to the frame engages ratchet teeth on the winding shaft to rotate the winding shaft in a strap take-up direction when the handle moves from a second to a first position while not rotating the winding shaft when the handle moves the first toward the second position. A lock mechanism actuated by a key is provided to positively and selectively lock the handle to the frame when the handle is in the second position. (Abstract.) However, the locking mechanism comprises a top-down key lock and the straps are not internally reinforced.

U.S. Pat. No. 7,448,596, Cable Tightening Device Having Anti-Theft Function, discloses a cable tightening device includes a fixed unit, a rotation member rotatably mounted on the fixed unit, a movable unit including a movable member to drive the rotation member and a release member to lock or unlock the movable member, and a locking unit to lock the release member onto the movable member releasably. Thus, the release member is locked onto the movable member by the locking unit and cannot be pulled upwardly to detach the push plates of the movable unit from the ratchet wheels of the fixed unit so that the ratchet wheels are locked to lock the rotation member to prevent the cable from being loosened so as to protect the cargo wound by the cable, thereby achieving the anti-theft purpose. (Abstract.) This design includes a combination lock introduced to the cam and does not reinforce the straps.

US 20240343180, Lockable Ratchet Strap, this device a ratchet strap comprising a locking mechanism. The first and second arms of the ratchet strap are configurable for disposition in a locking-ready relationship. While the first and second arms are disposed in the locking-ready relationship, the locking mechanism is configurable for disposition in a locking effective configuration and a locking ineffective configuration. While the first and second arms are disposed in the locking-ready relationship, and the locking mechanism is disposed in the locking effective configuration, rotation of the first arm, relative to the second arm, in a first direction or second opposite direction, is opposed. While the first and second arms are disposed in the locking-ready relationship, and the locking mechanism is disposed in the locking ineffective configuration, there is an absence of opposition of rotation of the first arm, relative to the second arm, in the first direction, by the locking mechanism. (Abstract.) This device, too, introduces a top-down keyed locking mechanism and fails to reinforce the straps.

US 2024/0308411, Magnetic Anchoring Strap System, improves the way in which a roof rack or luggage is secured to the roof of a vehicle, offering the most practical and simple way: providing means for a strap, attached to a roof rack or a load to be attached to a door frame of the vehicle, in a way that avoids the drawbacks of the previous techniques. In accordance with the teachings of the present invention, a magnetic anchoring strap system is provided which can be attached to a load strap that is set to be mounted directly to the door frame. The magnetic anchoring strap system can remain in position, in the door frame, regardless of the degree of tension on the load strap or the degree of pull on the magnetic anchor, as well as when the load strap is loose. (Abstract.) This concept uses a second strap to secure the goods to the vehicle frame and does not reinforce the straps.

US 2024/0409021, Suspended Tie Down Setup for Utility Vehicle Cargo Bays. This invention is a suspended tie down setup for utility vehicle cargo bays. The setup consists of adjustable vertical tie down brackets that allows low height cargo to be contained, restrained and secured using tie down webbing straps. The setup also includes fixed horizontal rails. The brackets have multiple slots for tie down cam buckle straps and holes for ratchet tie down hooks. The bracket design allows multiple tie down straps and hooks to be used simultaneously and in any combinations and tensions, resulting in different low height cargo types, shapes and sizes being stacked and contained, restrained and independently secured by a suspended device. The rails are the platform for the brackets and are designed to provide full adjustability, versatility and functionality. (Abstract.) This concept does not introduce a locking mechanism into the cam nor reinforce the straps.

U.S. Pat. No. 12,071,063, Method For Securing Cargo Boxes Upon The Bed Of A Pickup Truck Device For Securing Cargo Boxes Upon The Bed Of A Pickup Truck, provides A method for securing cargo boxes upon the bed of a pickup truck includes the steps of securing cargo rings to a structural portion of each inner side wall of the pickup truck; determining the distance separating adjacent cargo rings on each inner side wall; providing at least two strap members each having a longitudinal dimension greater than the distance separating cargo rings on a respective inner side wall, each of the two strap members having first and second portions, each portion having a hook end with a connecting hook secured thereto, the first portion having a cam buckle end integrally secured to a cam buckle, the second portion having a cam buckle end slidably secured to the cam buckle, resulting in the hook ends of each strap member being detachably secured to a respective cargo ring; whereby, cross straps detachably secured to strap rings secured to the strap members ultimately secure cargo boxes upon the bed of the pickup truck, and a tensile force vector imparted upon each strap member and extending parallel to the inner side walls of the pickup truck is reduced, thereby reducing the force urging together the cargo rings on each respective side wall of the pickup truck. (Abstract.) This concept does not introduce a locking mechanism into the cam nor reinforce the straps.

U.S. Pat. No. 11,116,288, Strap Tie-Down, provides an improved strap tie-down device that includes two primary components, namely a base frame and a lever arm, and further includes a cam and a locking mechanism. (Abstract.) This concept does not introduce a locking mechanism into the cam nor reinforce the straps.

U.S. Pat. No. 10,981,489, Cam Buckle Tie-Down, discloses a length of webbing in a tiedown assembly and configured for longitudinal passage therethrough of the webbing, includes a frame having a base; a cam pivotably coupled to the frame between a web-gripping portion and an actuation portion for movement between a secured position in which the web-gripping portion is positioned to grip the webbing against the base of the frame, and a release position in which the web-gripping portion is positioned to release the webbing from the base of the frame; a longitudinal cam groove in the gripping portion of the cam; and a plurality of gripping structures on the web-gripping portion of the cam, extending laterally on opposite sides of the cam groove. The base of the frame may advantageously have a longitudinal frame groove laterally aligned with the cam groove. (Abstract.) This concept does not introduce a locking mechanism into the cam nor reinforce the straps.

WO 2020/136368, Tie-Down Strap, A tie-down strap assembly is described. The tie-down strap assembly comprises a tie-down strap comprising a strap, having a set of sections including a first section and a second section comprising an end of the strap, and a tension device for tensioning the first section of the strap; a spool, comprising a barrel and a set SF of flanges, including a first flange, arranged to receive the second section of the strap spooled thereon; and a coupling member CM, comprising a first part and a corresponding second part, arrangeable to mutually couple the tie-down strap and the spool. The tie-down strap assembly is arrangeable in: a first configuration, wherein the tie-down strap and the spool are uncoupled; and a second configuration, wherein the tie-down strap and the spool are coupled. A method of arranging the tie-down strap assembly, the spool and a method of manufacturing the spool are also described. (Abstract.) This concept does not introduce a locking mechanism into the cam nor reinforce the straps.

U.S. Pat. No. 11,453,326, Tie Down Apparatus And System. This provides a tie down system having a first attachment member having an engagement portion adapted to engage with a portion of a track, a second attachment member having an engagement portion adapted to engage with a portion of the track, the second attachment member rotatably attached relative to the first attachment member, a cam member rotatably attached relative to the first attachment member, and rotatable between a biased position in which the cam member engages with a portion of the track and a release position in which the cam member is disengaged from the track, and a connection portion adapted to connect to a strap, wherein the first and second attachment members are rotatable relative to each other between an engagement position in which the engagement portions engage with the track and inhibit movement of the attachment members relative to the track, and an open position in which the attachment members are movable relative to the track. (Abstract.) This concept does not introduce a locking mechanism into the cam nor reinforce the straps.

US 2022/0379799, Adjustable Cargo Strap. This disclosure relates to an adjustable cargo strap configured with hook latches at both ends and cam buckles for tensioning the strap proximate to both ends. A series of pass-through connectors configure lengths of straps that run between the cam buckles forming one or two cargo areas where one or both cargo areas can be used to secure odd-shaped cargo easily. In operation, a user can secure the hook latches between the opening of a truck bed, or other span or opening. Cargo can be placed in the cargo areas. The loose ends of the cam buckle straps can be pulled to remove any slack in the straps. Each of the cam buckles can then be adjusted in ratchet or pull-and-grip style by the user to increase the force on the strap causing the cargo areas to be constricted around and secure the cargo. (Abstract.) This concept does not introduce a locking mechanism into the cam nor reinforce the straps.

U.S. Pat. No. 11,794,630, Cargo restraint system. This invention discloses a cargo restraint system for securing cargo on a truck bed of a truck is provided. The cargo restraint system includes a cargo retaining sheet having first and second end portions and an interior sheet portion disposed between the first and second end portions. The first and second end portions extend parallel to a longitudinal axis of the cargo retaining sheet and are spaced apart from another and form first and second apertures, respectively, therein. The cargo restraint system further includes a first adjustable length strap that extends through the first aperture in the cargo retaining sheet and is attachable to the truck. The cargo restraint system further includes a second adjustable length strap that extends through the second aperture in the cargo retaining sheet and is attachable to the truck. (Abstract.) Cargo restraint system

However, in those instances when the goods being secured must be left unattended, security is often lacking. Accordingly, it is an object of the present disclosure to provide an improved cam buckle and strap mechanism to enhance security for the materials secured by the cam buckle and strap.

Citation or identification of any document in this application is not an admission that such a document is available as prior art to the present disclosure.

### SUMMARY

The above objectives are accomplished according to the present disclosure by providing an improved anti-theft cam buckle and strap assembly designed to enhance the security of items secured using tie-down straps. The system may combine a mechanically lockable cam buckle with a cut-resistant strap incorporating one or more internal reinforcement strands. Together, these features address long-standing vulnerabilities in traditional cam buckle straps, which can typically be loosened by lifting a release lever or defeated by cutting the textile webbing.

In certain implementations, the cam buckle may include a frame defining a strap path and a cam or clamping feature pivotally coupled to the frame. A keyed locking mechanism may be mounted beneath the buckle in a low-profile, underslung orientation. When actuated, the locking mechanism may position a locking bar or blocker in the path of the cam lever so that the lever may be prevented from moving to its release position. Such physical interference may prevent unauthorized loosening of the strap even when the assembly is under tension. The lock body may be secured to the buckle frame using rivets or other fasteners selected to inhibit tampering.

To cooperate with an internally reinforced strap, the buckle frame and/or clamping feature may define a longitudinal concavity or groove along the strap path. The groove may be sized to receive a reinforcement strand—such as a steel cable or high-tenacity fiber cord—embedded within the webbing. A tapered or angled lead-in region may help self-center the reinforcement strand during tightening so that the strap may feed smoothly and clamp securely. The groove may be centered or laterally offset and may extend continuously beneath the cam lever. Embodiments incorporating multiple reinforcement strands may employ multiple grooves or a widened channel.

The strap may include a flexible webbing such as nylon, polyester, polypropylene, aramid, UHMWPE, or hybrid constructions, with one or more reinforcement strands extending substantially the full usable length of the strap. At one or both ends, the webbing may be folded and sewn so that the reinforcement strand overlaps through the stitched region, thereby reducing the possibility of a segment lacking the strand. Various hooks or end fittings may be attached to the strap ends, and tag-end loops may be configured for ergonomic pulling.

During use, a user may thread the strap through the buckle with the reinforcement strand aligned in the groove. Tension may be applied by pulling the free end of the strap, after which the cam lever may clamp the webbing in place. The user may then actuate the underslung locking mechanism to prevent release of the cam lever. Unlocking may require an appropriate key, after which the cam lever may be operated normally to loosen the strap and release the load.

The disclosed system may offer a combination of cut resistance, tamper-resistant locking, and compact geometry uncommon in conventional cam buckle straps. The design may reduce visibility and accessibility of the lock, may minimize snagging and wind-related issues, and may provide significant resistance to unauthorized removal of the strap or the secured property. The structure may be scaled for various strap widths, materials, and configurations and may be supplied individually or as part of a kit that may include matched straps and usage instructions.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows one embodiment of an anti-theft cam buckle strap of the current disclosure.

FIG. 2 shows a view of the second strap of an anti-theft cam buckle strap of the current disclosure.

FIG. 3 shows a view of a cam buckle of the current disclosure.

FIG. 4 shows one embodiment of a clamping feature removed from a cam buckle of the current disclosure.

FIG. 5 shows cross sectional views of webbing containing a reinforcement strand embedded in same.

FIG. 6 shows an anti-theft cam buckle strap in use.

FIG. 7 shows a cut away side view of an anti-theft cam buckle strap of the current disclosure.

FIG. 8 shows a top-down view of an anti-theft cam buckle strap of the current disclosure.

FIG. 9 shows a cut-away view of an anti-theft cam buckle strap of the current disclosure.

FIG. 10 shows a left-side view of one embodiment of a clamping feature of the current disclosure.

FIG. 11 shows a right-side view of one embodiment of a clamping feature of the current disclosure.

FIG. 12 shows a top-down view of one embodiment of a clamping feature of the current disclosure.

FIG. 13 shows an alternative embodiment wherein multiple reinforcement strands are included within the webbing.

FIG. 14 shows a flowchart for using an anti-theft cam buckle strap of the present disclosure.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping but rather should be read as “and/or” unless expressly stated otherwise. Similarly, a group of items linked with the conjunction “or” should not be read as requiring mutual exclusivity among that group but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used interchangeably herein, the terms “sufficient” and “effective,” can refer to an amount (e.g. mass, volume, dosage, concentration, and/or time period) needed to achieve one or more desired and/or stated result(s). For example, a therapeutically effective amount refers to an amount needed to achieve one or more therapeutic effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g. a web interface.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention. For example, in the appended claims, any of the claimed embodiments can be used in any combination.

All publications, published patent documents, and patent applications cited herein are hereby incorporated by reference to the same extent as though each individual publication, published patent document, or patent application was specifically and individually indicated as being incorporated by reference.

### Kits

Any of the anti-theft cam buckle and strap devices described herein can be presented as a combination kit. As used herein, the terms “combination kit” or “kit of parts” refers to the components, parts, pieces, modules, and any additional components that are used to package, sell, market, deliver, and/or provide the combination of elements or a single element, such as the anti-theft cam buckle and strap devices described herein. Such additional components include, but are not limited to, packaging, blister packages, and the like. When one or more of the components, parts, pieces, modules, and any additional components described herein or a combination thereof (e.g., an anti-theft cam buckle and strap devices provided alone or an anti-theft cam buckle and strap devices provided with constituent parts/pieces for installation) contained in the kit are provided simultaneously, the combination kit can contain the anti-theft cam buckle and strap devices alone or the anti-theft cam buckle and strap devices provided with other accoutrements for installation, modification, and/or upkeep. When the components, parts, pieces, modules, and any additional components described herein or a combination thereof and/or kit components are not provided simultaneously, the combination kit can contain the anti-theft cam buckle and strap devices and constituent parts in separate combinations. The separate kit components can be contained in a single package or in separate packages within the kit.

In some embodiments, the combination kit also includes instructions printed on or otherwise contained in a tangible medium of expression. The instructions can provide information regarding the anti-theft cam buckle and strap devices, installation/upkeep/maintenance information, information regarding use, etc. In some embodiments, the instructions can provide directions and protocols for installing an anti-theft cam buckle and strap devices or providing maintenance to same. In some embodiments, the instructions can provide one or more embodiments of the methods for making anti-theft cam buckle and strap devices of the current disclosure as any of the methods described in greater detail elsewhere herein.

Herein, a tie-down assembly includes a strap with an internal cut-resistant reinforcing member, a toothed cam buckle, and a groove along the strap path that is sized for the reinforcing member and shaped with a lead-in to help center it. A lock is mounted beneath the buckle and can be positioned to block the movement of the release lever. The groove extends continuously under the lever and is about as deep as the diameter of the reinforcing strands, and it may be centered, offset, or placed along an edge of the strap path. The lock is riveted to the buckle frame and has a die-cast metal body, and the frame itself has a triangular profile to make room for the lock located underneath.

The present disclosure relates to an anti-theft tie-down system that integrates a mechanically locking cam buckle with a cut-resistant strap architecture. In representative embodiments, a buckle frame defines a strap path across a base having strap-engaging features, while a cam lever is pivotally mounted to the frame for movement between a clamping position—where the lever frictionally retains a webbing in the strap path—and a release position that allows the webbing to slide for loosening. To prevent unauthorized loosening under load, a compact lock is mounted to the frame, preferably on the underside, and is configured so that, when actuated, a blocker physically interferes with travel of the cam's release or thumb lever, thereby blocking movement of the cam toward the release position. This lockout is a direct mechanical block rather than a mere frictional impediment, and in preferred constructions is achieved by translating a locking bar or rotating a blocker plate into the lever's path.

The strap cooperates with the buckle to deliver both tensioning and theft resistance. The webbing includes at least one internal, cut-resistant reinforcement strand—such as a metallic cable (e.g., galvanized or stainless wire rope in 7×7 or 7×19 constructions) or a high-tenacity non-metallic cord (e.g., aramid, UHMWPE, or LCP)—that extends along the usable length of the strap. To accommodate this internal member without compromising buckle function, the strap path of the frame and/or the clamping surface of the cam lever incorporates a longitudinal concavity or groove sized approximately to the diameter of the reinforcement strand. This groove preferably extends continuously beneath the cam lever through the clamping zone, includes a rounded root to reduce fretting, and features a tapered lead-in region that tends to self-center the strand as tension is applied. The groove may be centered on the strap width or deliberately offset toward one edge, and versions with multiple reinforcement strands are contemplated with corresponding multi-channel grooves or a widened concavity.

During use, the reinforced webbing is threaded through the buckle with the internal strand riding within the groove. The user pulls the tag end to tension the strap; the lead-in region guides any lateral misalignment so that the strand settles into the concavity, maintaining a consistent clamping interface. The cam lever is then rotated to its clamping position, where gripping teeth or textured surfaces on the frame and complementary projections on the lever resist back-feed. Once the desired tension is achieved—such as when slightly compressing a vehicle suspension to stabilize a motorcycle on a truck bed—the underslung lock is actuated. In the locking state, the blocker extends across an opening in the frame or swings into the travel path of the thumb lever such that the lever cannot be lifted sufficiently to release the strap, even under high tension where webbing thinning might otherwise be suspected to create clearance. Unlocking is performed with the appropriate key (e.g., pin-tumbler, wafer, disc-detainer, or sidebar mechanisms) or other authorized actuation, after which the thumb lever can be depressed in the normal manner to allow controlled loosening and removal.

The buckle and lock can be realized in robust, low-profile constructions. In certain embodiments the frame exhibits a triangular outer profile that positions the cam pivot and creates clearance for the underslung lock without increasing overall stack height. The lock body may be a die-cast metal housing retained to the frame using non-removable fasteners such as solid or semi-tubular rivets, blind rivets, peened pins, or swaged posts; security screws may be used in variants where removable service is desired. Internally, low-friction liners or guides can be included to smooth motion of a sliding locking bar. Environmental features—gaskets, drainage paths, or hydrophobic coatings—may be incorporated to manage debris and moisture, and the lock can be placed or contoured so that, when unlocked, its external surfaces are flush with or recessed relative to the underside of the frame to minimize snagging and reduce visual conspicuity.

The reinforced strap is likewise engineered to avoid obvious bypass points. At the strap's end region, the webbing is folded and sewn to itself in patterns such as box-X or multi-row bar tacks, with the reinforcement strand overlapped through the sewn region so that no segment of the end joint lacks the strand. Optional jackets—such as polymer coatings or TPU laminates—may be employed to enhance abrasion, weather resistance, and tooth engagement durability in the buckle-contact area. Tag ends may terminate in ergonomic pull loops free of metal fittings, while end hardware (e.g., J-hooks, T-hooks, or complementary hooks that lock together into a continuous loop) can be selected to suit the application.

This architecture is readily scaled for straps approximately one to two inches wide (and beyond), with groove depths preferably chosen within a tolerance band around the strand diameter—for example, within ±20%—to promote consistent seating and clamping. Materials for the frame and lever may include stamped or cast steel, stainless steel, aluminum, zinc alloys, or reinforced polymers, and the strap-engaging teeth can be integrally formed or provided as hardened inserts to improve wear life. In all variations, the combination of an internal cut-resistant member aligned by a dedicated groove and a positive mechanical lockout of the cam release provides a security profile not typical of conventional retail cam straps. The system may be supplied as a kit including the buckle, a matched reinforced strap (or a pair of straps for opposing sides of a load), and instructions describing threading, tensioning, and lock actuation procedures.

Operationally, the method of securing a load with the disclosed system comprises threading the reinforced webbing so that the internal strand engages the groove, tensioning by pulling the tag end while the groove's lead-in self-centers the strand, clamping the strap by rotating the cam lever, and then actuating the underslung lock so a blocker physically prevents the lever's release motion. To unload, the user unlocks the mechanism and depresses the thumb lever to allow controlled loosening. This sequence provides high holding power, reduced susceptibility to opportunistic release, and resistance to strap severing attempts, all within a compact, snag-resistant package suitable for vehicles, trailers, roof racks, utility installations, and other tie-down environments.

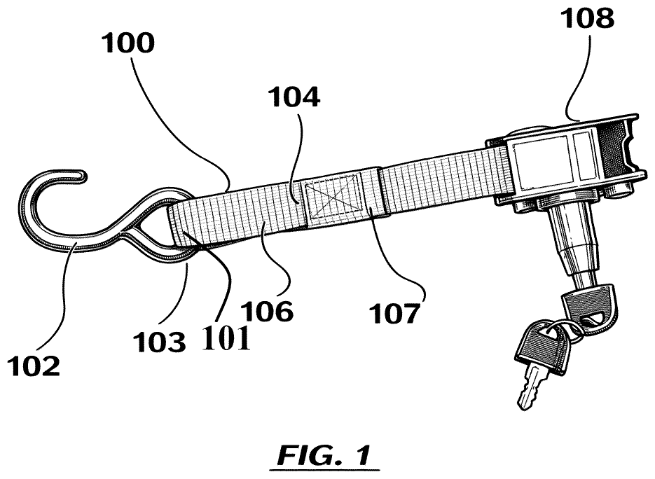

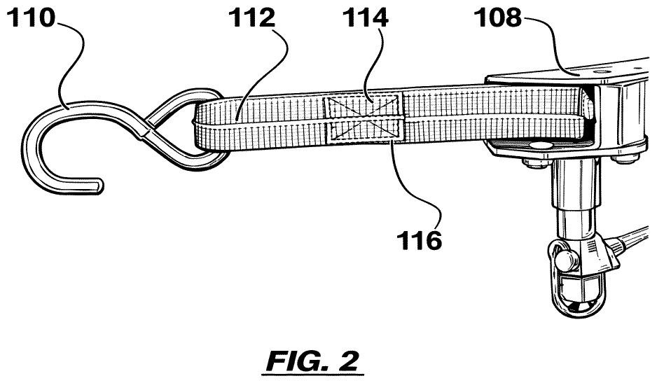

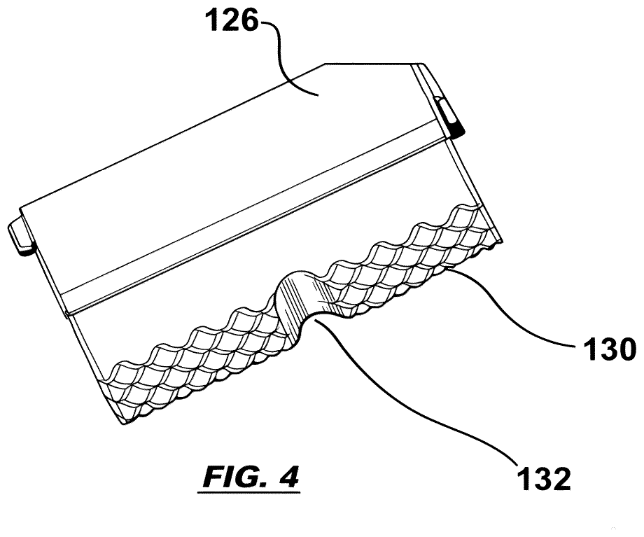

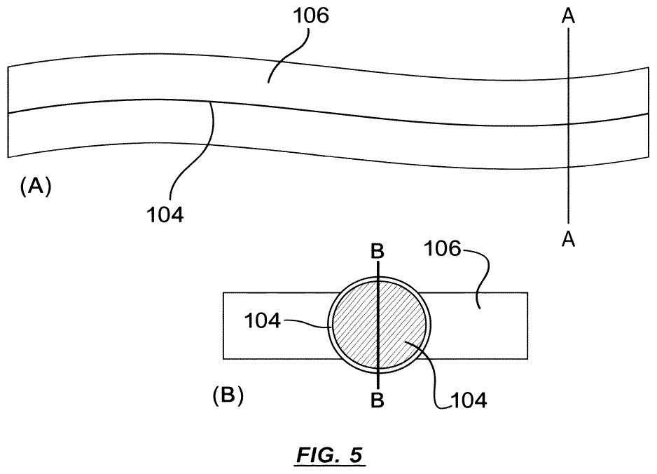

The current disclosure provides an anti-theft cam buckle strap 100, see FIG. 1, used to secure various loads or objects of value to a variety of support surfaces or immovable objects. The objects to be secured could include motorcycles, UTV's, ATV's, kayaks, boats, construction equipment, personal property, etc. and could be attached to anything from a vehicle, a trailer, a boat, a pallet, a shelf, a tray, a roof rack, a cage or a tree, etc. The strap has first hook 102. First hook 102 may be formed from metals, plastics, synthetics as known in the art. Further, first hook 102 may have varied shapes to accommodate different ways of affixing cam buckle strap 100 to various surfaces/attachment figures. For instance, first hook 102 may be a simple ‘J’ hook, may be configured with male/female engagement with second hook 110, see FIG. 2, folded into a “T” hook, formed with flanges on the sides for further frictional engagement, etc. That is, the appearance of first and second hooks 102 and 110 are not limited to simply the configurations shown in the Figures. First hook 102 engages on one end 103 with reinforcement strand 104. Reinforcement strand 104 may be a metallic cable, polymer cord, denser section of first webbing 106 formed by multiple layers of webbing localized in one area or multiple areas to form a thickened/denser portion of first webbing 106 to prevent or hinder cutting, tearing, or otherwise damaging first webbing 106. In one instance, reinforcement strand 104 may be a steel cable running through first webbing 106. Reinforcement strand 104 may be woven into first webbing 106 as it is being produced, please reference patent CN207998670U, which is hereby incorporated by reference to the extent not inconsistent herewith. FIG. 5 at (A) shows a top cross-section view of first webbing 106, cut at plane A-A, with reinforcement strand 104 embedded in first webbing 106 in substantially the middle of first webbing 106. However, this placement is not static, and the current disclosure is not so limited. Indeed, clamping feature 126, see FIG. 4, may have engagement depression 132 configured to engage reinforcement strand 104 (through first webbing 106) wherever reinforcement strand 104 is located within first webbing 106. FIG. 5 at (B) shows a front-facing facing cross section view at plane B-B of first webbing 106 with reinformed strand 104 running laterally through same and disposed entirely within first webbing 106.

Reinforcement strand 104 may be encased in first webbing 106 and fed through cam buckle 108 and then attached to itself at first affixment location 107, see FIG. 1. While shown as unitary and unable to be removed from buckle 108 due to lapping back onto itself, first webbing 106 may be made separable from buckle 108. Second hook, 110, see FIG. 2, is attached to second reinforcement strand 112, a shorter piece of cable, encased in second webbing 114 passed through cam buckle 108 and then sewn onto itself at affixment location 116.

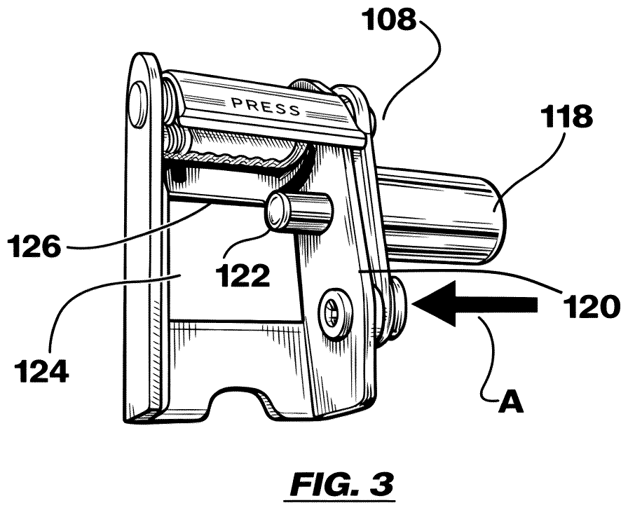

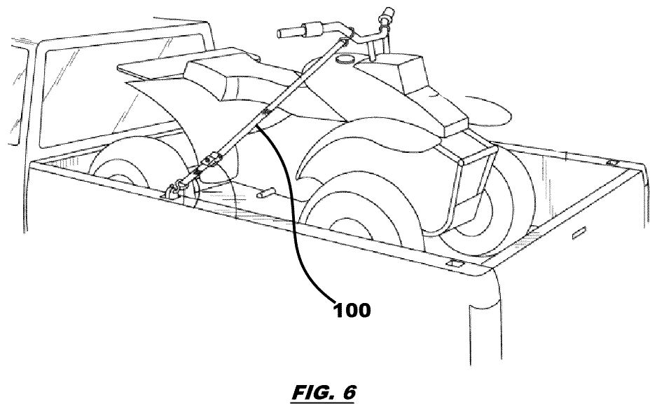

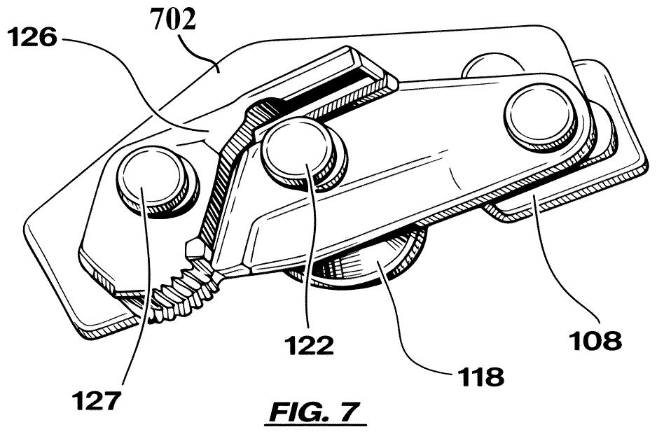

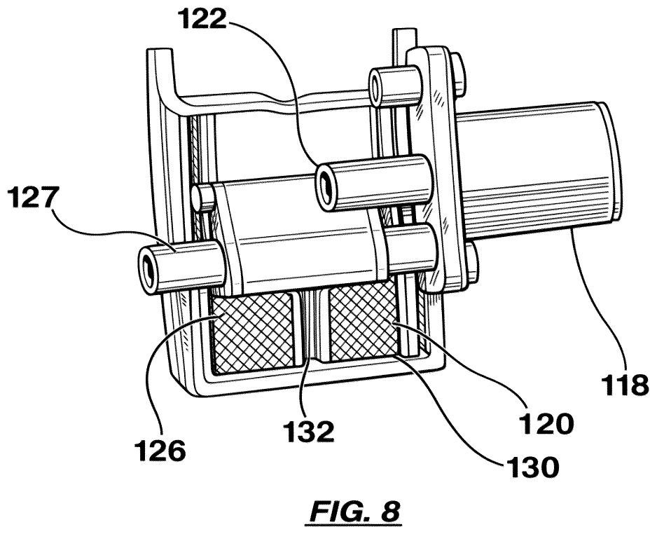

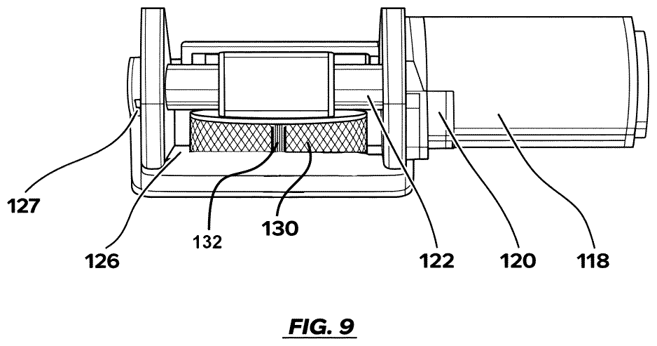

In use, one hook, e.g., first hook 102, may be attached to a support surface and the other hook, e.g., second hook 110, may be attached to the load being secured. One will then pull down on the loose end of the webbing. FIG. 6 shows one example of anti-theft cam buckle strap 100 in use, applying tension and securing the load/property. To prevent the unwanted release of buckle 108, see FIG. 3, keyed locking feature 118 can be pressed inward, see arrow A, with respect to buckle outer wall 120, thus extending locking bar 122 through buckle outer wall 120 into buckle interior 124, preventing clamping feature 126 from actuating, by rotating on axle 127 positioned through axle orifice 129, of clamping feature 126, by releasing its grip on with first webbing 106 or second webbing 114, whichever is frictionally engaged with clamping feature 126, which presses down on the webbing and secures it into place within buckle 108. FIG. 7 shows a cut away view of buckle 108 revealing clamping feature 126. Locking bar 122, when engaged, extends overtop of clamping feature top surface 131, preventing it from rotating “backwards” or “upwards” and releasing engagement depression 132 from reinforcement strand 104 and releasing gripping surface features 130 from either first webbing 106 or second webbing 114, whichever is running through anti-theft cam buckle strap 100. First hook 102 and second hook 110 may also be linked together around an object and a platform, bar, pole, etc., to form a loop to secure an object within the loop and affixed to the platform, bar, pole, etc. Locking bar 122 in combination with first reinforcement strand 104 and/or second reinforcement strand 112 prevents unlocking the buckle as well as prevents cutting of either first webbing 106 or second webbing 114. The quantity and diameter of first and second reinforcement strands 104 and 112 may vary based on the model of buckle employed as well as the load being secured. FIG. 8 shows a top-down view of an anti-theft cam buckle strap of the current disclosure. FIG. 9 shows a cut-away view of an anti-theft cam buckle strap of the current disclosure.

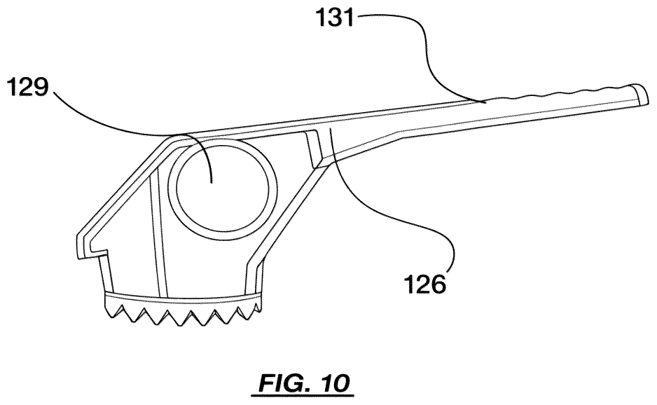

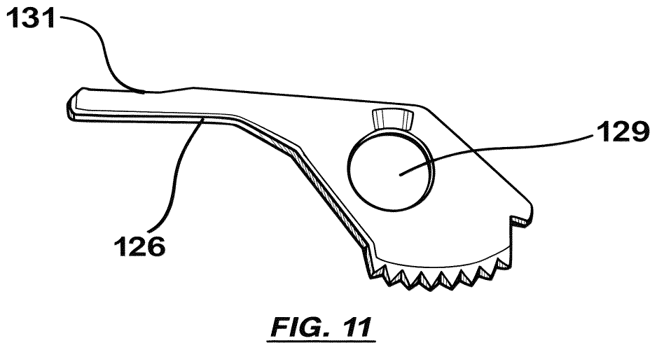

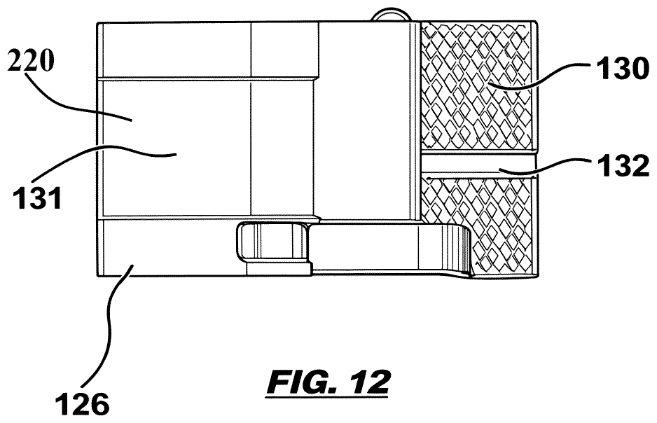

FIG. 4 shows clamping feature 126 removed from cam buckle 108. FIGS. 10, 11, and 12 show side views and a top-down view of clamping feature 126. Clamping feature 126 may include gripping surface features 130, which may be formed as teeth or “grips” to hold first webbing 106 and second webbing 114 in place preventing the webbing from slipping or sliding once inside cam buckle 108. Clamping feature 126 may also define reinforcement strand engagement depression 132. This depression forms a valley or cleft in the clamping feature 126. This serves to accommodate either first reinforcement strand 104 or second reinforcement strand 112 and allows same to pass through cam buckle 108 unimpeded, as long as locking bar 122 is not engaged. The presence of either reinforcement strand in first webbing 106 or second webbing 114 increases the diameter of same and would prevent the webbing from being used in a typical cam/buckle arrangement. Clamping feature 126 defining engagement depression 132 further secures the webbing in place as well as prevents attempts to “slide” the webbing within cam buckle 108 to loosen same.

The current disclosure overcomes various failings with prior art devices, as keyed locking feature 118 being oriented horizontally with respect to cam buckle 108 and first webbing 106 or second webbing 114 not only secures cam buckle 108 in a “closed” position but also physically prevents removal of first webbing 106 or second webbing 114 from cam buckle 108 by locking bar 122 preventing release of clamping feature 126 from either first webbing 106 or second webbing 114.

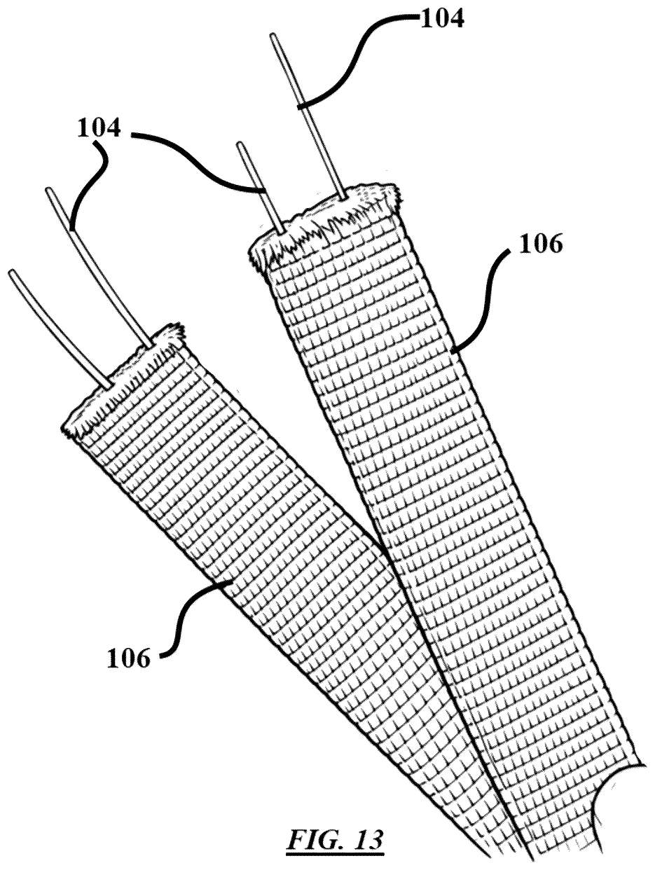

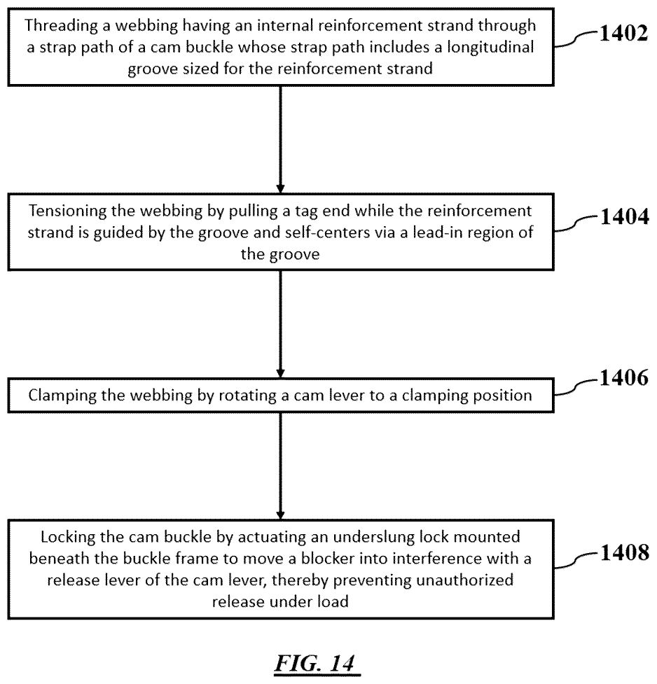

FIG. 13 shows an alternative embodiment wherein multiple reinforcement strands 104 may be included in the webbing. FIG. 14 shows a flowchart of an example method for using an anti-theft cam buckle of the current disclosure. At step 1402, a webbing having an internal reinforcement strand is threaded through a strap path of a cam buckle whose strap path includes a longitudinal groove sized for the reinforcement strand. At step 1404, the webbing is tensioned by pulling a tag end while the reinforcement strand is guided by the groove and self-centers via a lead-in region of the groove. At step 1406, the webbing is clamped by rotating a cam lever to a clamping position. At step 1408, the cam buckle is locked by actuating an underslung lock mounted beneath the buckle frame to move a blocker into interference with a release lever of the cam lever, thereby preventing unauthorized release under load.

To use the product, first place an item such as a motorcycle into the bed of a truck. Attach the hook on the long side of the strap to an anchor point inside the truck bed. Next place the vinyl-coated hook on the handlebars of the motorcycle. Then remove the slack from this strap by pulling down on the tag end. Repeat these steps for the second strap. Then pull down on both straps slightly compressing the shocks of the motorcycle to ensure stability. Finally press the lock in. To remove the motorcycle, using the provided key unlock the cam gripper and press the thumb release of both straps. Remove the hooks from the handlebars and then remove the motorcycle from the bed of the truck.

Anti-theft cam buckle strap 100 comprises a flexible web (e.g., woven or knit polymer webbing forming first webbing 106 and second webbing 114) with a first reinforcement strand 104 and second reinforcement strand 112 extending substantially the usable length of the strap. The reinforcement strands are depicted as a steel cable sized to provide cut resistance rather than load-bearing tensile capacity; the flexible web's working tensile strength may remain primarily a function of the webbing itself. The reinforcement strands internal cable may overlap across the strap end joints, with the web ends sewn together such that no local weak point exists that could be exploited to bypass the cable, such as an area of webbing with no cable running therethrough. Thus, reinforcement strand extends to the strap ends and the sewn joint overlays the cable run to avoid a circumvention point.

### Cam Buckle Frame and Teeth

Cam buckle frame 200 includes strap-engaging teeth 210 that resist back-feeding of the strap when the cam is closed. Cam buckle frame 200 includes a thumb release lever 220 which, when depressed, normally relieves tooth engagement to allow loosening. In embodiments herein, the lever's travel is selectively blocked by a lock to prevent unauthorized release under load.

Cable Guiding Groove with Lead-in and Self-Centering Configuration

Formed in the buckle's strap path is a reinforcement strand engagement depression 132 that may form a groove, channel or other concave depression sized and shaped to accommodate the reinforcement strands. In one embodiment, the reinforcement strand engagement depression 132 has a depth approximately equal to the cable diameter (e.g., about 1/16 inch but can vary from 1/32 to as thick as ½ inch depending on the configuration of the device and thickness of the cable), with a lead in angle and/or minute taper that self-centers the reinforcement strands during tightening to reduce lateral roll off, minimize wear, and maintain consistent clamping engagement. Thus, the reinforcement strands stay centered and do not disengage from reinforcement strand engagement depression 132 even after repeated usage. Reinforcement strand engagement depression 132 may extend continuously along the length of the strap path beneath the lever so that no obstruction impedes sliding during installation and tightening, while still allowing the lever to press fully against the webbing for secure grip.

Although centering reinforcement strand engagement depression 132 is generally preferred, reinforcement strand engagement depression 132 may alternatively be offset anywhere across the strap width (left, right, or adjacent an edge) to accommodate handed configurations or other design objectives, with equivalent function and advantages contemplated. Indeed, as shown in FIG. 13, multiple reinforcement strands may run in parallel along the webbing requiring multiple reinforcement strand engagement depressions 132 formed as well.

### Locking Mechanism; Low Profile Under-Slung Geometry

Keyed locking feature 118 is arranged beneath (under-slung relative to) the buckle frame, such that in an extended position it allows authorized operation, and in a retracted/engaged position it blocks motion of the thumb release lever 220 and prevents tension release. The under-frame location enables a low-profile package that reduces snagging, wind resistance, and visual conspicuity. This makes the lock less obvious to would-be thieves.

In one implementation, keyed locking feature 118 is zinc (e.g., die-cast), with internal sliding components (e.g., a plastic mortise/liner) providing smooth actuation. In preferred constructions keyed locking feature 118 is retained by rivets rather than screws to discourage tampering and disassembly. Tumbler codes may be changed periodically across production lots (e.g., approximately every 250-300 units) to reduce the risk that a single key opens numerous straps in the market. Replacement lock bodies and replacement keys may be omitted from the program to maintain security integrity.

### Frame Geometry; Triangular Profile and Alternatives

Unlike typical oval/oblong frames, certain embodiments utilize a triangular frame profile 702. The triangular geometry is selected based on lever pivot positioning relative to the frame and the need to accommodate the under-slung lock beneath the body; in some layouts an oval frame would place the pivot pin higher than desired, while a triangular contour creates clearance for the lock without increasing overall height. Other polygonal contours may be used while preserving these relationships.

### Width Options; Strength Considerations

Anti-theft cam buckle strap 100 is manufacturable in multiple strap widths (e.g., from about 1 inch to about 2 inches, including measurements beyond and within these ranges). The weak point in comparable systems is often the buckle, as thin constructs or cheaply made or weak materials enable thieves to disassemble other devices, and scaling width enables a correspondingly larger, stronger buckle to increase system capacity while retaining the anti-tamper architecture.

### Tag End Loop Variations

The ends of first webbing 106 and second webbing 114 strap's tag end loop may be fashioned with removable first hook 102 and second hook 112 such that only a free loop 101 is at the free end of first webbing 106 and second webbing 114 dimensioned for ergonomic pull insertion and may be lengthened or otherwise re-sized to provide enhanced grip for the operator without altering the core functionality.

### Performance Considerations

Concerns that high strap tension could thin the webbing like a stretched rubber band, potentially permitting lever movement, were evaluated under extreme load. Testing indicated that the lever cannot be lifted sufficiently to release the strap under such conditions; additionally, the internal reinforcement strands do not appreciably stretch or neck down during tension usage.

### Benefits Over Conventional Products

Anti-theft cam buckle strap 100 combines cut resistance (via internal reinforcement strands) and keyed lockout of the cam release, features not offered singly or in combination in common retail straps, while maintaining a lower profile that reduces wind buffeting and snag potential and renders the lock less visible.
Materials Listing
   A. Strap (webbing) and Internal Cut Resistant Member

The Webbing/Strap Body may comprise polymeric and hybrid materials such as: Polyamides: Nylon 6, Nylon 6,6 (standard tie-down webbings); Polyesters: PET; high-tenacity polyester webbings; Polypropylene: Isotactic PP webbings (lightweight, lower cost); Polyurethanes (TPU): TPU-coated polyester/nylon webbing for abrasion, hydrolysis, and weather resistance; Ultra High Molecular Weight Polyethylene (UHMWPE): e.g., Dyneema®, Spectra® tapes or blended weaves for high strength to weight and cut resistance; Aromatic Polyamides (Aramids): Kevlar®, Twaron®, etc. either as full webbing or as reinforcing picks in a nylon/polyester base for cut resistance; Liquid Crystal Polymer (LCP): Vectran® tapes; PBO: Zylon® fibers (with UV protection schemes); Fluoropolymers (laminates): ePTFE or PTFE-coated fabrics for chemical resistance; PEEK or PPS fibers/tapes: for high-temperature use cases; Hybrids: Woven blends (e.g., nylon/aramid; polyester/UHMWPE), knit tapes, braided sleeves around flat webbing, or composite laminates (e.g., TPU-laminated UHMWPE web); Elastomeric add-ons: Silicone or EPDM friction pads localized to the tooth engagement zone; Textile finishes: UV inhibitors, flame retardants (FR), antimicrobial finishes, hydrophobic coatings (DWR), anti-wick barriers, colorants (solution-dyed yarns) to preserve strength outdoors.

The reinforcement strands may be made from: Ferrous metals: Galvanized carbon steel cable (7×7, 7×19, or similar); Stainless steels: AISI 302/304/305/316/17-7PH wire rope; music wire (high-carbon spring steel) where applicable; Nonferrous metals; Titanium alloys (e.g., Ti 6Al 4V) wires/strands (excellent strength to weight, corrosion resistance); Nickel superalloys: Inconel®, Monel® (for corrosion-severe environments); Aluminum alloys: 5xxx/6xxx series wire/strands (lighter weight; lower absolute cut resistance than steel but viable in some embodiments); Copper alloys: Brass/bronze strands (conductive/EMI tag options); Metal treatments/coatings; Zinc, Zn Ni, or Al Zn coatings; polymer jacketing (PVC, TPU, polyolefin) to reduce fretting inside the strap; Case hardening or nitriding on discrete cable segments for cut resistance; Nonmetallic cut-resistant cords (as alternatives or adjuncts); Aramid cords (Kevlar®/Twaron®) braided cores; UHMWPE (Dyneema®/Spectra®) cords or hybrid aramid/UHMWPE braids; LCP (Vectran®) or PBO cords where heat/creep performance is needed.

The reinforcement strands may also possess various geometry options including: single strand, multi-strand wire rope, braided cords, flat cables, or multiple parallel members; overlapped ends through the sewn joint to avoid circumvention.

The webbing may be stitched or joined in various ways as well including: thread; bonded nylon or bonded polyester (UV resistant); aramid or UHMWPE thread for cut/heat resistance. Various stitching patterns may be used as well including box x, bar tack, or multi-row lockstitch; overlap of the internal cable within the stitched region to eliminate a local weak point.

Adhesive assists for fastening the webbing may be employed as well including two-part epoxies, urethane hot melts, or RF weldable TPU layers (for laminated straps).

The tie-down assembly may include various end fittings or tag-end loops, which can be reinforced using materials such as leather, TPU, Hypalon®, or molded thermoplastic tabs. The length and geometry of the loop may be varied to improve user grip or accommodate different handling preferences. The lock body and its internal mechanics may be formed from metals including zinc die casting, aluminum, magnesium, brass, or stainless steel, and may alternatively or additionally incorporate engineering polymers such as acetal, PBT, glass-filled nylon, PC/ABS, PPS, or PEEK for higher-temperature applications. Low-friction liners or sliding components may be implemented using PTFE-filled POM or UHMWPE inserts, and optional ceramic inserts such as alumina or zirconia may be included to increase resistance to drilling or picking. Suitable surface finishes include nickel, chrome, zinc plating, black oxide, anodizing for aluminum components, ceramic-filled epoxy coatings, electro-coatings, or PVD hard films such as TiN or DLC to protect wear surfaces. Security features may include periodically varied tumbler configurations to reduce key commonality across production batches, and in some programs replacement keys or lock swaps may not be offered.

The cam buckle frame and lever may be manufactured from stamped or cast steel, stainless steel, aluminum for weight reduction, or zinc alloys. In some embodiments the lever may be formed from reinforced polymers such as glass-filled nylon or acetal. Teeth for strap engagement may be integrally formed in the metal frame or provided as hardened inserts made of tool steel, carbide-tipped elements, or nitrided steel for enhanced durability. The frame may exhibit a triangular profile that positions the lever pivot and provides space for an underslung lock beneath the buckle body; alternative shapes such as oval or polygonal contours may also be used while still providing the necessary clearance. A groove for receiving the internal cable or reinforcement member may be machined, cast, coined, or molded into the frame. This groove may include a lead-in and slight taper to self-center the internal member, with a depth approximately matching the diameter of the cable, and may run continuously beneath the lever. Centered and offset groove configurations are both contemplated.

Fastening methods for securing the lock to the frame may include solid, semi-tubular, or blind rivets formed from steel, stainless steel, aluminum, or Monel®, providing a non-removable attachment. Alternatives such as peened pins, swaged posts, or security screws, including one-way or pin-Torx® types, may be used where rivets are impractical, and structural adhesives such as acrylics or epoxies may provide supplemental retention. Springs may be made from music wire, stainless steel, or phosphor bronze, and pins or axles may be formed from hardened carbon steel, stainless steel, or through-hardened tool steel with protective finishes such as black oxide or nitriding.

The device operates as a non-ratcheting cam strap in which tensioning is accomplished by pulling the tag end, while the underslung lock prevents the lever from being actuated for release. The groove and lock configuration may be readily scaled for tie-down straps of one-inch or two-inch widths, with wider buckle bodies contributing to higher overall system strength. The lock cavity may optionally incorporate environmental sealing features such as gaskets, drainage paths, or hydrophobic coatings to resist debris ingress while preserving a low-profile geometry. By locating the lock beneath the buckle body, the design reduces visibility to potential tamperers and minimizes snagging and wind loading during transport.

This construction provides a combination of internal cut resistance and mechanical lockout of the cam buckle release, a capability not typically available in consumer-grade tie-down straps. The low-profile lock placement yields a compact and snag-resistant form factor with reduced wind buffeting and improved concealment. Riveted construction discourages disassembly, and periodically varied tumbler designs reduce key duplication across units. Testing under extreme tension indicates that the strap cannot be thinned in a manner that would allow unauthorized lever actuation, and the internal cable maintains its integrity without significant necking. The system architecture accommodates variations in groove position, strap width, materials, and frame shape, allowing manufacturers to configure multiple embodiments without departing from the primary inventive concept.

The tie-down assembly may include various end fittings or tag-end loops, which can be reinforced using leather, TPU, or Hypalon® patches, as well as molded thermoplastic tabs. The length and geometry of these loops may be varied to improve grip and usability. The lock body and its internal mechanics may be constructed from metals such as zinc die-cast material, aluminum in either die-cast or machined form, magnesium, brass, or stainless steel. Suitable polymeric materials may also be used for the lock body or for internal liners and sliding components, including acetal, PBT, glass-filled nylon, PC/ABS, PPS, and high-temperature polymers such as PEEK. Low-friction liners or sliding elements may be formed from PTFE-filled acetal or UHMWPE inserts, and optional hard inserts made of alumina or zirconia may be incorporated to resist drilling or picking. A variety of coatings can be applied, including nickel, chrome, zinc plating, black oxide, anodizing for aluminum, ceramic-filled epoxy coatings, electro-coats, and PVD hard films such as TiN or DLC to protect wear surfaces and cut-interface components. Security can be enhanced by periodically varying tumbler configurations to prevent the emergence of a universal key across a production group, and in some implementations replacement keys or lock swaps are intentionally not provided.

The cam-buckle frame and lever may be formed from stamped or cast steel, stainless steel, aluminum for weight reduction, or zinc alloys, with certain embodiments using polymeric levers made of glass-filled nylon or acetal. The buckle teeth may be integrally formed in a metal frame or provided as hardened inserts made from tool steel, carbide-tipped materials, or nitrided steel to improve wear resistance. The frame may employ a triangular profile that positions the lever pivot effectively and accommodates an underslung lock beneath the buckle body, while alternative frame contours—such as oval or polygonal shapes—may also be used so long as they preserve necessary clearance. A groove for receiving a cable or reinforcement member may be machined, cast, coined, or molded into the frame, and typically incorporates a lead-in and modest taper to enable self-centering of the member. The groove is generally about the same depth as the diameter of the cable, for example approximately one-sixteenth of an inch, and may extend continuously beneath the lever. Versions with centered or offset groove placements are contemplated as well.

The lock may be secured to the frame using solid, semi-tubular, or blind rivets made of steel, stainless steel, aluminum, or Monel®, providing a non-removable attachment. Where rivets are unsuitable, alternatives such as peened pins, swaged posts, or security screws—including one-way and pin-Torx® fasteners—may be employed. Structural adhesives such as acrylics or epoxies may provide additional retention. Springs used in the mechanism may be formed from music wire, stainless steel grades such as 302 or 17-7 PH, or phosphor bronze, while pins and axles may be made from hardened carbon steel, stainless steel, or through-hardened tool steel with protective finishes such as black oxide or nitriding.

The device operates as a non-ratcheting cam strap in which tension is applied by pulling the tag end of the strap, while the underslung lock prevents actuation of the release lever. The groove and lock design may be scaled for straps of one-inch or two-inch width, with wider buckles providing higher system strength. Optional environmental sealing may be incorporated into the lock cavity, including gaskets, drainage paths, or hydrophobic coatings to prevent debris intrusion while maintaining a low-profile construction. The underside placement of the lock also reduces visibility, helping to deter tampering and minimizing snagging and wind loading during transport.

This design provides notable advantages. It combines internal cut resistance, provided by the cable reinforcement, with mechanical lockout of the cam-buckle release—capabilities not typically found together in retail tie-down straps. The underslung lock contributes to a compact, snag-resistant profile with reduced wind buffeting and lower visual prominence. Riveted construction discourages disassembly, and periodic tumbler variations reduce key commonality across units. Testing under high tension shows that the strap cannot be thinned sufficiently to allow unauthorized lever actuation and that the internal cable does not appreciably neck under load. The system supports broad manufacturing flexibility, as groove placement, strap width, material selection, and frame contour—whether triangular or polygonal—can be adjusted without departing from the core inventive concept.

A variety of alternative lock mechanisms may be used with cam-buckle tie-down assemblies. Key-operated mechanical locks include pin-tumbler cylinder locks, which resemble traditional Yale-type designs and can be miniaturized for low-profile mounting while supporting keyed-different, keyed-alike, and master-key configurations. Wafer-tumbler locks offer a slimmer profile and are commonly used in luggage and filing cabinets, making them well suited for shallow lock-body applications. Disc-detainer locks, such as Abloy-style mechanisms with rotating disc stacks, provide high resistance to drilling and picking and are useful for premium anti-tamper versions. Sidebar cylinder locks, which employ rotating sidebar elements, also offer strong pick resistance. Non-key mechanical options include combination dial locks with three- or four-dial mechanisms that eliminate the need for a physical key and may be mounted on the side or underside of the buckle. Push-button combination locks use multiple mechanical buttons to generate a coded sequence and can be packaged with a low profile. Mechanical digit-wheel slider locks rely on sliding coded wheels rather than dials, enabling a very thin form factor.

Additional mechanisms include latch-blocking and wedge-based devices that directly prevent movement of the release lever or cam arm. These include translating wedge locks that slide into position to prevent downward lever motion and can be actuated by a miniature key or combination input and may be housed within the triangular frame. Rotating blocker plates use a disc or plate that swings into a blocking position, operating through a key or combination wheel. Spring-biased blocking pins can pop into a notch on the cam lever and retract only after keyed or coded actuation. Ratcheting pawls with lockout features may also be used, in which a pawl engages a tooth pattern and the lock prevents the pawl from being withdrawn. Magnetic and magnetically actuated solutions may be employed, such as magnetic key locks that use encoded rare-earth magnet patterns to align internal gates, or magnetic-detent interlocks that keep the lever blocked unless a magnetic field properly aligns internal detents, permitting extremely low-profile external designs.

Electronic and electromechanical mechanisms are also applicable. RFID- or NFC-activated locks can unlock the lever using a key fob or contactless card, whether battery-powered or battery-free via NFC energy harvesting. Bluetooth-controlled solenoid locks can be opened via a smartphone app and may record access events for fleet or security monitoring. Capacitive-touch electronic locks allow the user to tap a sequence on touch pads without exposing a mechanical interface. Piezoelectric micro-actuated locks can use vibration-driven actuators to move a blocking pin and are small enough for compact installations. Hybrid mechanical-electronic systems may include electromechanical combination locks in which buttons mechanically set gates while a small solenoid validates the code and provides failsafe access if the battery is depleted. Motorized servo blockers may rotate a blocker element into or out of engagement and can be concealed entirely within the triangular frame cavity.

Other options include tamper-evident or one-way locking systems that do not unlock but instead show evidence of unauthorized access. Single-use break-seal interlocks require cutting for removal and are suitable for cargo or seal-integrity applications, while frangible pins or clips break if tampering occurs. Mechanical encapsulation systems may also be used, such as sliding shield enclosures that surround and lock the lever, functioning as a lockable shell, or clamshell housings that close around the buckle and strap path and secure with either a key or combination. Finally, the cam-buckle frame may incorporate hasps for use with external padlocks. A frame-mounted hasp may be formed as a machined eyelet located beneath the frame to accept a user-supplied padlock of any common keyed, combination, or smart-lock variety, while dual-hasp configurations use two aligned openings that prevent lever movement when locked, allowing compatibility with a wide range of padlock types.

Further embodiments are illustrated in the following Examples which are given for illustrative purposes only and are not intended to limit the scope of the disclosure.

Various modifications and variations of the described methods, compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features hereinbefore set forth.

What is claimed is:

1. An anti-theft tie-down assembly comprising:
a buckle frame defining a strap path;
a cam lever pivotably coupled to the buckle frame and movable between a clamping position that frictionally retains a webbing in the strap path and a release position that permits the webbing to slide;
a lock mounted to the buckle frame and configured, when in a locking state, to physically block movement of the cam lever from the clamping position toward the release position; and
a flexible webbing having at least one reinforcement strand configured as internal and cut-resistant extending along a length of the webbing;
wherein a clamping feature of the cam lever defines a longitudinal groove along the strap path sized to receive the reinforcement strand so that the webbing slides during tensioning and is clampable with the reinforcement strand received in the longitudinal groove, and wherein the longitudinal groove includes a lead-in configured to self-center the reinforcement strand during tightening.

2. The anti-theft tie-down assembly of claim 1, wherein the lock is mounted below the buckle frame and includes a locking bar that, in the locking state, extends into a travel path of the cam lever to block upward movement of a thumb-actuated release portion of the cam lever.

3. The anti-theft tie-down assembly of claim 1, wherein the longitudinal groove is centered on a width of the strap path.

4. The anti-theft tie-down assembly of claim 1, wherein the longitudinal groove is offset from center toward a lateral edge of the strap path.

5. The anti-theft tie-down assembly of claim 1, wherein the longitudinal groove extends continuously beneath the cam lever across a region in which the webbing is clamped.

6. The anti-theft tie-down assembly of claim 1, wherein the cam lever comprises a clamping feature having gripping surface projections and a reinforcement-strand engagement depression aligned with the longitudinal groove.

7. The anti-theft tie-down assembly of claim 1, wherein the webbing comprises nylon, polyester, polypropylene, UHMWPE, aramid, or combinations thereof.

8. The anti-theft tie-down assembly of claim 1, wherein the buckle frame has a triangular outer profile configured to provide clearance for the lock without increasing overall height of the buckle frame.

9. The anti-theft tie-down assembly of claim 1, wherein the lock is secured to the buckle frame by rivets that are non-removably deformed in place.

10. The anti-theft tie-down assembly of claim 1, wherein the longitudinal groove has a depth within ±20% of a diameter of the reinforcement strand.

11. The anti-theft tie-down assembly of claim 1, further comprising end fittings at opposite ends of the webbing selected from J-hooks, T-hooks, or mating hooks configured to form a continuous loop around an anchor structure.

12. The anti-theft tie-down assembly of claim 1, wherein the reinforcement strand extends substantially an entire length of the webbing between opposite end fittings.

13. The anti-theft tie-down assembly of claim 1, wherein the webbing includes multiple reinforcement strands running in parallel and the strap path defines corresponding multiple longitudinal grooves.

14. The anti-theft tie-down assembly of claim 1, wherein the lock, when in an unlocked state, is flush with or recessed relative to a lower surface of the buckle frame to reduce snagging and visibility.

15. A cam buckle comprising:
a buckle frame having a strap-engaging base and a strap path;
a cam lever mounted to the buckle frame for rotation about an axis and having a web-gripping portion and an actuation portion;
a blocker movable between a non-blocking state and a blocking state in which the blocker interferes with travel of the actuation portion to prevent rotation of the cam lever toward a strap-releasing position; and
a reinforcement-strand accommodation feature formed along the strap path as a longitudinal concavity having a depth approximately equal to a diameter of a reinforcement strand intended to be carried within a webbing received by the buckle, the concavity extending under the cam lever.

16. The cam buckle of claim 15, wherein the blocker is actuated by a key-operated cylinder mounted beneath the buckle frame and translates laterally into a space above the cam lever.

17. The cam buckle of claim 15, wherein the concavity includes a rounded root radius to reduce fretting of an embedded cable.

18. A method of securing a load using a cam buckle tie-down, comprising:
threading a webbing having an internal reinforcement strand through a strap path of a cam buckle whose strap path includes a longitudinal groove sized for the reinforcement strand;
tensioning the webbing by pulling a tag end while the reinforcement strand is guided by the longitudinal groove and self-centers via a lead-in region of the longitudinal groove;
clamping the webbing by rotating a cam lever to a clamping position; and
locking the cam buckle by actuating an underslung lock mounted beneath a buckle frame to move a blocker into interference with a release lever of the cam lever, thereby preventing unauthorized release under load.

19. The method of claim 18, wherein locking comprises translating a locking bar across an aperture in a sidewall of the buckle frame to overlie a top surface of the cam lever.

20. The method of claim 18, further comprising unlocking with a key and depressing a thumb release to move the cam lever to the release position to remove the load.
